(19) United States
(12) Patent Application Publication
(10) Pub. No.: US 2026/0133389 A1
(43) Pub. Date: May 14, 2026

(54) ASSEMBLY WITH AT LEAST TWO SEQUENTIALLY ARRANGED PHOTONIC INTEGRATED CIRCUITS OR STACKS OF PHOTONIC INTEGRATED CIRCUITS

(71) Applicant: Q.ant GmbH, Stuttgart (DE)

(72) Inventors: Louise Hoppe, Stuttgart (DE); Niklas Hoppe, Stuttgart (DE)

(21) Appl. No.: 19/372,968

(22) Filed: Oct. 29, 2025

(30) Foreign Application Priority Data
Oct. 29, 2024 (DE) 10 2024 131 556.3

(51) Int. Cl. G02B 6/43; G02B 6/42

(52) U.S. Cl. CPC G02B 6/43; G02B 6/4202

(57) ABSTRACT

An assembly comprising a first and a second photonic integrated circuit (PIC) or a first and a second PIC stack, wherein the second PIC or PIC stack is rotated relative to the first PIC or PIC stack about a light propagation axis of couplers arranged between optical outputs of the first PIC or PIC stack and optical inputs of the second PIC or PIC stack, in particular rotated by ninety degrees.

### FIELD

The invention relates to an assembly with a first and a second photonic integrated circuit (photonic integrated chip, PIC) or a first and a second PIC stack.

### BACKGROUND

Conventional chip-to-chip interfaces of PICs are usually implemented with a parallel orientation of the connected PICs and often use chip-to-fiber-to-chip coupling.

Such couplings are limited in terms of losses and additional functionalities of the interfaces and the resulting chip stacks.

WO 2023/003 983 A1 describes an integrated photonic arrangement which has two or more photonic integrated sub-circuits. Different coupling methods are described.

US 2022/0 343 149 A1 describes an arrangement which comprises three PICS which overlap to form a stack structure. Neighboring PICs are connected by a coupler.

U.S. Pat. Nos. 5,009,477 A, 9,442,254 B2 and US 2023/0 375 784 A1 each disclose an assembly.

The object of the present invention is to provide an assembly which enables denser packaging of PICs or PIC stacks.

The first PIC or PIC stack can extend parallel to a first level and the second PIC or PIC stack can extend parallel to a second plane and the second plane can be rotated about an axis relative to the first plane, i.e., not aligned parallel to the first plane. The first and second PIC or the first and second PIC stack therefore have different orientations. In particular, the first and second PIC or PIC stack are arranged directly one after the other, i.e., without the interposition of another PIC or PIC stack. In other words, they are arranged sequentially. The light propagation axis corresponds here to the light propagation direction.

Such an assembly can be realized without additional chip-to-fiber-to-chip coupling. In addition, three-dimensional PIC architectures are possible, which avoids the use of waveguide crossings. A lossy polarization change on the PICS can thereby be prevented. External polarization rotation in the fibers between individual PICS is avoided. In accordance with the invention, the light propagation direction or light propagation axis in the couplers is taken into account, since the light propagation direction on a PIC can vary, for example, when beam splitters are used.

Usual polarizations of the optical wave in the waveguide are described by TM and TE (transverse electric and transverse magnetic, respectively). The primary direction of the electric field in TM is vertical to the chip surface or waveguide surface and in TE the direction is parallel to the level of the chip surface, and additionally for both cases approximately vertical to the waveguide direction or propagation direction. Usually only one of the polarizations is used, e.g., TE in x-cut LNOI (Lithium Niobate on Insulator). However, z-cut LNOI uses TM. To change the polarization on the second PIC or PIC stack, the second PIC or PIC stack is connected at an angle of 90° and thus the rotation of the E-field is completed in accordance with the invention. Such a rotation comes without additional on-chip components. In addition, the on-chip components used alternatively for this purpose (asymmetric etching of the waveguide) are susceptible to manufacturing tolerances or errors. This means that such components tend not to rotate the polarization completely, which can lead to unwanted interference effects. Furthermore, there would be no need for solutions with λ/4 filters or polarization adjusters using bulk elements (opposite of on-chip component) between the PICS or PIC stacks to be implemented if the other polarization is needed on the second PIC or PIC stack.

The optical outputs of the first PICs or PIC stack can be coupled directly to the optical inputs of the second PICs or PIC stack, in particular without the interposition of optical fibers. On the one hand, this results in a higher packing density. On the other hand, optical fibers can be saved. In particular, consecutive PICs or PIC stacks may have chip-to-chip coupling. Such chip-to-chip coupling can be realized via conventional waveguide-to-fiber couplers, without the fiber as an intermediate piece. This can be advantageous for the tolerances during adjustment because the waveguide cross section is smaller than the waveguide-fiber interface. The optical outputs and the optical inputs can in particular be arranged on top of one another, in particular arranged lying directly on each other.

The outputs of the first PICs or PIC stack can be coupled to the inputs of the second PICs or PIC stacks by means of end-facet couplers or fiber couplers. In this case the couplers can incorporate the waveguide end pieces at the chip edge.

Since these waveguide end pieces at the chip edge (rim or edge of a PIC) usually have dimensions that differ from the standard waveguide, they can be considered and named as a separate component.

In accordance with one embodiment of the invention, it can be provided that the outputs of the first PICs or PIC stack with the inputs of the second PICs or PIC stack are coupled by means of end-fire coupling. End-fire coupling refers to a method of energy coupling into or energy coupling out of a waveguide, in which the electromagnetic wave is mainly directed along the axis or direction of the waveguide. This coupling technique is characterized by the fact that the waves propagate along the end or the lateral edge of the waveguide (not the edge of the waveguide end).

Furthermore, it can be provided that the number of inputs of the second PIC stack corresponds to the number of PICs of the first PIC stack. Alternatively or additionally, it can be provided that the number of optical outputs of the first PIC stack corresponds to the number of PICs of the second PIC stack. If these constraints are met and the positions of the PIC inputs and outputs of the two PIC stacks are coordinated after rotation, they can be aligned and packaging can be performed with direct chip-to-chip end-facet coupling. The number of inputs of the first PIC stack and the number of outputs of the second PIC stack can be selected independently of the chip-to-chip coupling and can be freely selected.

The optical inputs of the first PICs or PIC stack and/or the optical outputs of the second PICs or PIC stack can be coupled to a fiber array or a fiber matrix. This allows source-to-chip coupling or chip-to-detector coupling to be realized. When fiber arrays are used, they can be assigned to the PICS either in parallel or in a rotated orientation, as long as the coupling interfaces between a vertical array and a horizontal stack or between a horizontal array and a vertical stack are properly aligned.

In accordance with a variant of the invention, more than two PICs or PIC stacks can be connected sequentially. The number of sequentially connected PICs or PIC stacks is limited substantially by the propagation losses in the interconnected PICS or PIC stacks.

The last PIC stack can be coupled via a waveguide loop coupler to the input of the first PIC stack. This is a good method to determine the optical transmission for actively positioning the PIC stack.

Furthermore, it can be provided that photodiodes and/or glass fibers are arranged on the last PIC stack. These can be mounted on-chip or coupled.

Further features and advantages of the invention will become apparent from the following detailed description of exemplary embodiments of the invention with reference to the figures of the drawing, which show details essential to the invention, as well as from the claims. The features shown there are not necessarily to scale and are presented in such a way that the special features in accordance with the invention can be clearly seen. The various features can be implemented individually or in groups in any combination in variants of the invention.

### BRIEF DESCRIPTION OF DRAWINGS

The schematic drawing shows exemplary embodiments of the invention in various stages of use and is explained in more detail in the following description.

In the drawings:

FIG. 1 shows two PIC stacks before their coupling;

FIG. 2 shows two PIC stacks of which the couplers are assigned to each other;

FIG. 3 shows two directly coupled PIC stacks,

FIG. 4 shows an arrangement with nested PICS.

### DETAILED DESCRIPTION

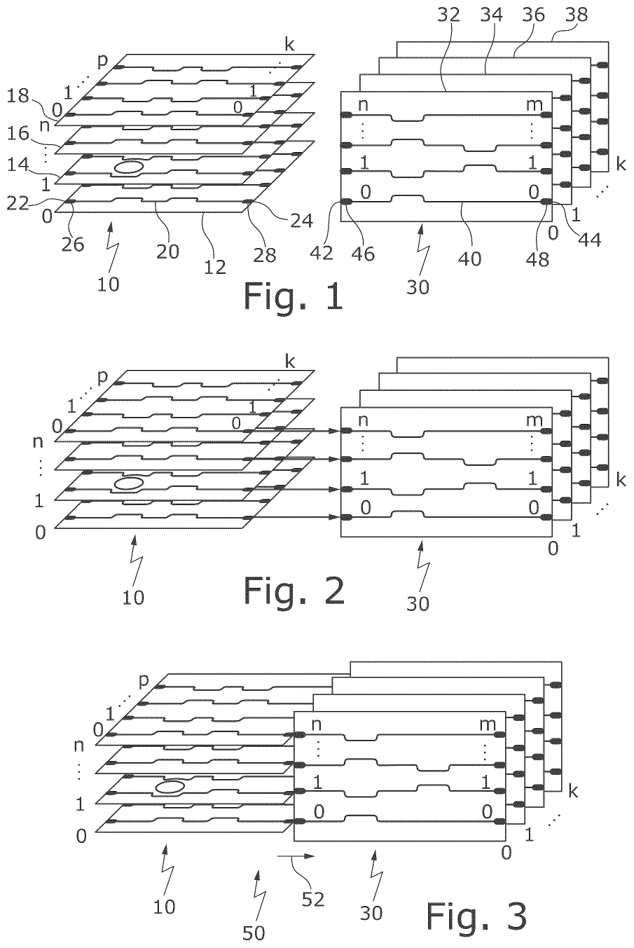

FIG. 1 shows a first stack 10 with several PICs 12, 14, 16, 18 stacked horizontally above one another. Only 4 PICs are shown, but in fact 0, 1 . . . n PICs 12-18 can be stacked on top of each other. Each PIC 12-18 has waveguide structures 20, wherein only one waveguide structure 20 of the PIC 12 is provided with a reference number. Each PIC 12-18 has optical inputs 22 and optical outputs 24. Couplers 26, 28 are arranged at the optical inputs 22 and the optical outputs 24. Each PIC 12-18 has 0, 1 . . . p optical inputs 22 and 0, 1 . . . k optical outputs 24.

Furthermore, FIG. 1 shows a second PIC stack 30, which has vertically stacked PICS 32, 34, 36, 38. In particular, the second PIC stack 30 following the first PIC stack 10 has 0, 1 . . . k PICs 32-38. Each PIC 32 has a waveguide structure 40. Each PIC 32-38 has optical inputs 42 and optical outputs 44, at each of which a coupler 46, 48 is arranged. Each PIC 30 has 0, 1 . . . n optical inputs 42 and 0, 1 . . . m optical outputs 44. In particular, in the exemplary embodiment shown the number of PICS 12-18 corresponds to the number of optical inputs 42 of the PIC stack 30. The number of optical outputs 24 of PICs 12-18 corresponds to the number of vertically stacked PICs 32-38. Furthermore, it can be provided that the number of outputs of the PIC stack 10, or the number of optical outputs 24, corresponds to the number of inputs of the PIC stack 30, or the number of optical inputs 42.

In order to connect the PIC stacks 10, 30, they are first arranged, as shown in FIG. 2, so that the optical outputs 24 are aligned with the optical inputs 42. Subsequently, the PIC stacks 10, 30 can be directly coupled to one another, as shown in FIG. 3, so that an assembly 50 is formed from two sequentially coupled PIC stacks 10, 30. The PIC stacks 10, 30, in particular the outputs 24 and the inputs 42, are coupled to each other directly, i.e., without the interposition of an optical fiber. There is therefore a chip-to-chip coupling. It can be seen that the PICs 32-38 of the chip stack 30 were rotated about a light propagation axis 52 of the couplers 28 at the outputs 24 and of the couplers 46 at the inputs 42, in particular were rotated by 90°.

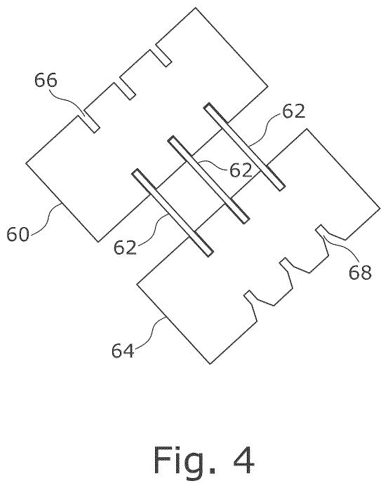

FIG. 4 shows an exemplary embodiment in which a first PIC 60 is coupled to second PICs 62, wherein the second PICs 62 are rotated by 90° compared to the first PIC 60. In particular, the second PICs 62 are rotated by 90° relative to the first PIC 60 about a light propagation axis of the couplers arranged between the optical outputs of the first PIC 60 and the optical inputs of the second PICs 62, not visible in the drawing.

A third PIC 64 is coupled to the second PICs 62 also rotated by 90°.

The PICS 60, 62, 64 have recesses 66, 68 for inserting additional PICs. The recesses can go completely through a PIC, or only partially. The PICS 60, 62, 64 also have recesses on the sides facing each other, which are not visible in FIG. 4. The PICS 60, 62, 64 are coupled together in the region of these recesses.

1-11. (canceled)

12. An assembly comprising:
a first and a second photonic integrated circuit (PIC) or a first and a second PIC stack,
wherein the second PIC or PIC stack is rotated relative to the first PIC or PIC stack about a light propagation axis of couplers arranged between optical outputs of the first PIC or PIC stack and optical inputs of the second PIC or PIC stack,
wherein the second PIC or PIC stack is rotated by ninety degrees, and
wherein the first PIC or the PICS of the first PIC stack include recesses for inserting additional PICs, and/or the second PIC or the PICS of the second PIC stack include recesses for inserting additional PICs.

13. The assembly of claim 12, wherein the optical outputs of the first PIC or PIC stack are coupled directly to the optical inputs of the second PIC or PIC stack without the interposition of optical fibers.

14. The assembly of claim 12, wherein the outputs of the first PIC or PIC stack are coupled to the inputs of the second PIC or PIC stack by end-facet couplers or fiber couplers.

15. The assembly of claim 12, wherein the outputs of the first PIC or PIC stack are coupled to the inputs of the second PIC or PIC stack by end-fire coupling.

16. The assembly of claim 12, wherein the PICs include couplers adapted for end-fire coupling at end facets of their waveguides.

17. The assembly of claim 12, wherein the number of optical inputs of the second PIC stack corresponds to the number of PICs of the first PIC stack.

18. The assembly of claim 12, wherein the number of optical outputs of the first PIC stack corresponds to the number of PICs of the second PIC stack.

19. The assembly of claim 12, wherein the optical inputs of the first PIC or PIC stack and/or the optical outputs of the second PIC or PIC stack are coupled to a fiber array or a fiber matrix.

20. The assembly of claim 12, wherein more than two PICs or PIC stacks are provided.

21. The assembly of claim 12, wherein a last PIC stack is coupled via a waveguide loop coupler to an input of the first PIC stack.

22. The assembly of claim 12, wherein photodiodes and/or glass fibers are arranged on a last PIC stack.
